(19) United States
(12) Patent Application Publication
(10) Pub. No.: US 2013/0098115 A1
(43) Pub. Date: Apr. 25, 2013

(54) Molten Silica Roll with Heating System for Glass Tempering and Thermal Treatment of Materials

(71) Applicant: Airton Antonio Oecksler, Gaspar (BR)

(72) Inventor: Airton Antonio Oecksler, Gaspar (BR)

(21) Appl. No.: 13/807,239

(22) PCT Filed: Jun. 30, 2011
(86) PCT No.: PCT/BR11/00212

§ 371 Date: Dec. 27, 2012

(30) Foreign Application Priority Data
Jul. 1, 2010 (BR) PI 1002370-4

(51) Int. Cl. C03B 13/16

(52) U.S. Cl. CPC C03B 13/16
USPC 65/370.1

(57) ABSTRACT

A fused silica roll with a heating system internally built inside the roll for use in horizontal glass tempering furnaces or for thermal treatment of glass or other materials; made of a fused silica roll of heating, built in the shape of a cylinder with longitudinal circular tunnel of housing to the electrical resistance of heating, connected to the electrical terminals of the rotary contacts of mercury.

### FIELD OF THE INVENTION

The present invention refers to a fused silica roll with a heating system incorporated into the roll for using in horizontal tempering glass furnaces or thermal treatment of other materials.

### BACKGROUND OF THE INVENTION

In the current state of art the fused silica rolls are used exclusively for the transportation and oscillation of the glass inside of the heating chamber of the glass tempering furnace or treatment of materials due to its excellent thermal property.

The glass tempering process is composed of four basic steps: glass loading, heating, cooling and unloading.

In the current state of the art, the heating chamber is responsible for the glass heating by radiation and natural or forced convection process through electrical resistances installed on the top and bottom of the heating chamber, where the rolls are only used in the function of previous glass transportation and oscillation of short advancement and return during the heating.

There are several known patents focused on the glass manufacturing and treatment. There is also know a great variety of glasses produced, such as acid-etched glass, antireflective glass, wired glass, self-cleaning glass, low emission glass, beveled glass, bulletproof glass, bent glass, double glazed glass, extra clear glass, sandblasted glass, reflective glass, screen printed glass, tempered glass, among others which use and need new technologies to improve quality and increase productivity.

What is needed therefore is a roll of fused silica designed to perform the transportation and oscillation function of the glass inside the heating chamber, a detail already included in the state of the art, and also, to perform the technology required herein, which is the role of heating through electrical resistance inside the roll, whose main object is to heat the glass or the material to be treated.

### SUMMARY OF THE INVENTION

The present application seeks to provide a fused silica roll with a heating system for tempering glass and thermally treating materials comprising: (a) a heating roll shaft (6) in a shape of a cylinder with a longitudinal circular tunnel (9); the roll defining an internal movement axis (X), a first end (12) having first nozzle (5) attached to the roll and a second end (13) having second nozzle (5a) attached to the roll; the nozzles defining respectively a first hole (10) and a second hole (10a); (b) a set of first and second bearings (4 and 4a) respectively housed on the first and second shaft ends; (c) an electrical resistance (8), in a resistive massive bar-shaped or spiral-shape, accommodated inside the longitudinal circular tunnel (9); (d) a first stainless steel electrical terminal (2) and a second stainless steel electrical terminal (2a), respectively insulated by first and second insulation ceramic bushings (7) and (7a); the first and second electrical terminal fitted inside the holes (10 and 10a), and (e) a first mercury rotary contact (1) provided at the first end (12) and a pulley (3) and a second mercury rotary contact (1a) provided at the second end (13).

### BRIEF DESCRIPTION OF THE DRAWINGS

FIG. 1 shows an exploded perspective view of the fused silica roll with a heating system internally built for the heat treatment of glass and materials.

FIG. 2 shows a front view of the fused silica roll with a partial cut for the inside detailing, where the opposing sides are substantially identical.

FIG. 3 shows a back view of the fused silica roll, with the opposite sides substantially identical.

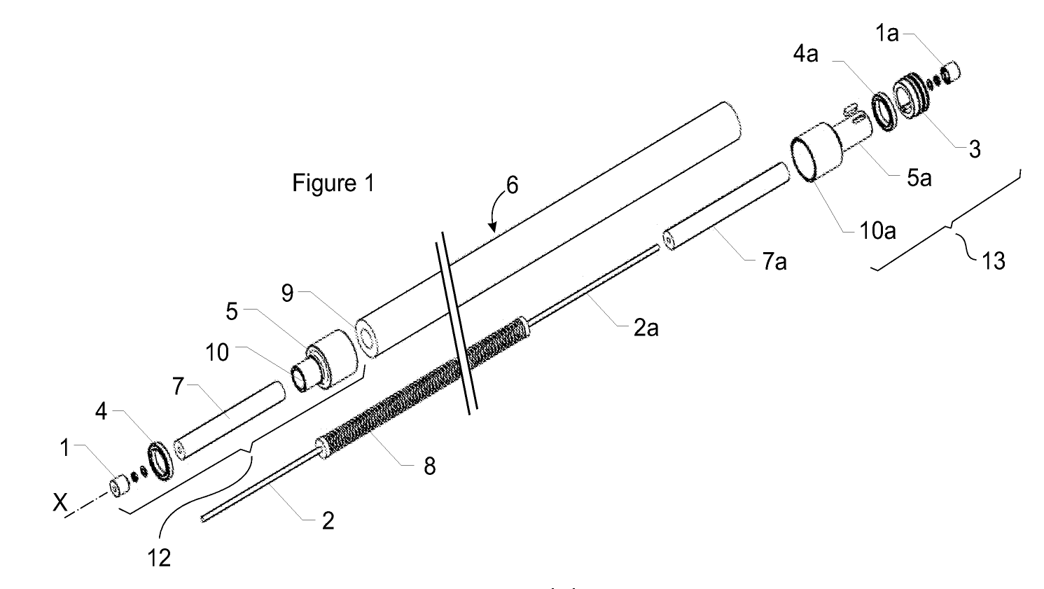

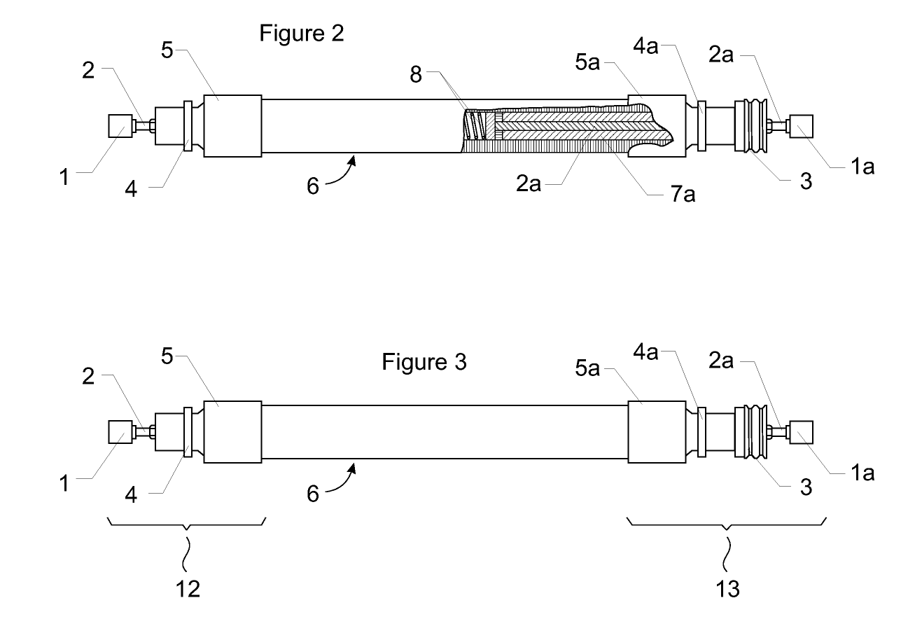

### DETAILED DESCRIPTION OF THE INVENTION

The silica roll of the present application has the function of glass transportation and oscillation inside the heating chamber and also the function of heating the material in contact with the roll that is heated by electrical resistance installed inside the roll. The roll is designed so that the wall thickness of the hollow cylinder, manufactured of refractory material similar to a tube, has a maximum transfer rate of heat produced through the resistance housed inside.

Terminals interconnected with the electrical resistance housed inside the roll are installed at the ends of the rolls, to perform the connection between the roll in rotating movement with the electric circuit of the machine power. Mercury rotating metallic contacts are installed in the terminals of the ends of the rolls, and theses rotating contacts can be also manufactured in copper or silver collecting rings and coal or graphite brushes.

The heating through the fused silica roll presents much more efficient and practical technological innovations when compared to the traditional system currently used in the prior art, which currently performs the heating of the furnace through electrical resistances installed inside the heating chamber of the furnace, at the top and at the bottom.

The present application presents many advantages in relation to prior art, such as (a) increased productivity by the rapid heating of the material through thermal conduction provided by direct contact between the heated roll and the glass or material to be treated, which results in greater productivity with reduced cycle of time in production; (b) increase in the heat transfer rate between the roll and the glass or the material to be treated with increased efficiency, resulting in energy savings, and (c) gains in the reduction of losses on thermal energy resulting from heat irradiation of the electrical resistance installed near the insulation in the inside of the furnace heating.

Another improvement achieved with the present application is the no need of labor currently required for assembly and installation of electrical resistances at the bottom and at the top of the heating chamber in conventional models or, if necessary, to keep only the electrical resistances of the top.

Significant reduction in raw material such as insulation, profiles, structures, metal plates, supports for electrical resistances and other materials resulting from the reduction on the size of the heating chamber, or because they are not necessary in the process of the present invention.

Another advantage are the gains in industrial physical space due to the reduction in the size of the heating chamber resulting from the increased efficiency of thermal heat transfer rate, in the case of continuous production furnaces.

The reduction in time to start the production process resulting from the rapid heating of the roll for the start of production is also an important achievement of the present application. The necessary time for heating the furnace to the ideal working temperature, is lower when compared to the current technology used in the prior art, which requires much longer time to heat and homogenize the temperature inside the chamber of the furnace.

Another advantage presented by the roll as claimed herein is achieved in case of burning of the heating electrical resistance. In this case it can be replaced without the need for shutting down and stopping the machine for a long period and waiting for the natural cooling of the furnace heating chamber. This electrical resistance replacement can be done with the chamber heated and without the need of opening and disassembling the furnace, which does not currently occur in traditional furnaces. With the furnaces of the prior art it is necessary to shutdown the machine for a period of approximately 40 hours for the natural cooling of the chamber, and only after this period the chamber can be opened to have the electrical resistance replaced.

Another important technological improvement achieved with the present application is the significant increase in the electrical resistance lifespan, which is now housed inside the roll and isolated from the internal atmosphere of the heating chamber and free from the contact with this oxidizing or reducing atmosphere.

A further achievement of the present application is the significant decrease in burnings or defects of electrical resistances, from the bottom of the furnace, caused by possible glass breakage inside the heating chamber where glass particles at temperatures above 500 degrees Celsius become electrically conductive and cause a short circuit between the electrical resistance when in contact with them, and therefore, causing them to burn.

The roll of the present invention was thoroughly tested and improved to have its practical functionality tested and proven. Also, support and adaptability to possible changes in the model of electrical resistances to be used inside the roll was tested.

Another variant that the roll may provide is related to the material used as heating element, which can be made of carbon, graphite, metal wires for electrical resistance or other heating elements. The electrical resistances can also be supported by quartz tube and have temperature sensors installed internally the roll to possible monitoring, and that also, it is not intended to limit the different ways or number of electrical resistances used inside the heating roll, which may vary according to the need in its commercialization

The electrical heating resistance can be manufactured with a self-compensation temperature material in order to demand greater heat output in the area of the roll where the temperature is lower, and to demand less heat input where the temperature is higher.

The fused silica roll claimed herein may be made from other materials such as quartz, alumina, ceramics, porcelain and materials of future technologies, with the possibility of being used in other equipment and materials, not only to the process of heating and tempering of glass, ceramics, metals and polymers.

As it can be seen from the figures, in the present application a set of bearings (4 and 4a) are housed over the shaft ends and first nozzle (5) and second nozzle (5a), the nozzles defining respectively a first hole (10) and a second hole (10a); the nozzles attached to the heating roll shaft (6) of a cylindrical shape, having a circular longitudinal tunnel (9) for accommodating an electrical resistance (8); the electrical resistance has a resistive massive shape or a tubular bar-shaped or spiral-shape connected to first and second stainless steel electrical terminals (2 and 2a) at the ends, and insulated by first and second insulation ceramic bushings (7 and 7a), which are fitted in the holes (10 and 10a) of the first and second nozzles (5 and 5a). The nozzles receive the bearings (4 and 4a) externally, with the second end (13) provided with a pulley (3) and the second mercury rotary contact (1a), and the first end (12) provided with the first mercury rotary contacts (1).

The pulley (3) provided at the second end (13) is responsible for transmitting the rotational movement of the rotation of the entire assembly supported by the bearings (4 and 4a) around its own axis, which also rotates the first and second mercury rotary contacts (1 and 1a), making the electrical connection between the first and second stainless steel electrical terminals (2 and 2a) and the electric circuit of the power machine.

The heating roll shaft (6) is manufactured with fused silica or refractory material in a cylindrical shape with longitudinal circular tunnel (9). The fused silica roll (6) is heated from the inside to the outside through the heating of the electrical resistance (8) housed in the longitudinal circular tunnel (9), which associated to the wall thickness of the heating roll shaft (6) produces a maximum rate of heat transfer.

The first and second stainless steel electrical electrical terminals (2 and 2a) of electrical connection allows for the electricity conduction between the electrical resistance (8) and the first and second mercury rotary contacts (1 and 1a), which transfer the electricity to the external electrical resistance (8) regardless of being in a rotational movement or in a static position.

The isolation between the electrical terminals (2 and 2a) and the axes and first and second nozzles (5 and 5a) is performed through first and second insulation ceramic bushings (7 and 7a) or other insulating material with refractory and insulating features, the first and second electrical terminal fitted inside the first and second holes (10 and 10a)

The bearings (4 and 4a) housed over the shaft ends and first and second nozzles (5 and 5a) assembled to the heating roll shaft (6) on the first end (12) and on the right side (13) act as a support for the support table of the furnace for the rotation of the heating roll shaft (6).

The mercury rotary contacts of (1 and 1a) may be presented in the form of a copper collector ring and coal brush.

The electrical resistance (8) is capable of having specific temperature compensation features to achieve a maximum thermal power generation in regions having low temperatures and minimum thermal power generation in regions having high temperatures.

The fused silica roll with the internally built heating system meet the requirements for functionality, mechanical resistance, robustness and durability that its use requires. Also meet all the necessary security requirements, combining changing of known elements in shape and innovative arrangement in its construction and practical application.

1-9. (canceled)

10. A fused silica roll with a heating system for tempering glass and thermally treating materials comprising:
(a) a heating roll shaft (6) in a shape of a cylinder with a longitudinal circular tunnel (9); the roll defining an internal movement axis (X), a first end (12) having first nozzle (5) attached to the roll and a second end (13) having second nozzle (5a) attached to the roll; the nozzles defining respectively a first hole (10) and a second hole (10a);
(b) a set of first and second bearings (4 and 4a) respectively housed on the first and second shaft ends;
(c) an electrical resistance (8), in a resistive massive bar-shaped or spiral-shape, accommodated inside the longitudinal circular tunnel (9);
(d) a first stainless steel electrical terminal (2) and a second stainless steel electrical terminal (2a), respectively insulated by first and second insulation ceramic bushings (7) and (7a); the first and second electrical terminal fitted inside the holes (10 and 10a), and
(e) a first mercury rotary contact (1) provided at the first end (12) and a pulley (3) and a second mercury rotary contact (1a) provided at the second end (13).

11. The fused silica roll according to claim 10, wherein the pulley (3) transmitting the rotational movement from the roll (6) rotation around the axis.

12. The fused silica roll according to claim 10, wherein the roll (6) is manufactured in fused silica or refractory material.

13. The fused silica roll according to claim 10, wherein heating is transmitted from an inside section to an outside section through the heating of the electrical resistance (8) accommodated inside the longitudinal circular tunnel (9).

14. The fused silica roll according to claim 10, wherein the first and second electrical terminals (2 and 2a) allow for electricity conduction between the electrical resistance (8) and the first and second mercury rotary contacts (1 and 1a), independently if the roll, is in a rotational movement or in a static position.

15. The fused silica roll according to claim 10, wherein the first and second insulation ceramic bushings (7 and 7a) are manufactured from insulating material with refractory and insulating features.

16. The fused silica roll according to claim 10, wherein the first and second bearings (4 and 4a) act as a support for the rotation of the roll shaft (6).

18. The fused silica roll according to claim 10, wherein the first and second mercury rotary contacts are presented in the form of a coal ring-brush.
